(19) United States
(12) Patent Application Publication
(10) Pub. No.: US 2017/0176688 A1
(43) Pub. Date: Jun. 22, 2017

(54) Network Switch With Augmented Input and Output Capabilities

(71) Applicant: Hamid Mehrvar, Ottawa (CA)

(72) Inventor: Hamid Mehrvar, Ottawa (CA)

(21) Appl. No.: 14/972,501

(22) Filed: Dec. 17, 2015

(51) Int. Cl. G02B 6/35; H04B 10/03; H04Q 11/00

(52) U.S. Cl. CPC G02B 6/3542; H04Q 11/0005; H04B 10/03; G02B 6/356; G02B 6/3562; H04Q 2011/0043

(57) ABSTRACT

A non-blocking N×N photonic switch may be augmented with additional inputs and outputs to make use of the excess switch capacity. An augmented photonic switch comprises an N×N non-blocking switching core connected between 2N inputs and 2N outputs.

### TECHNICAL FIELD The current application relates to network switches, and in particular to switches having a non-blocking switching architecture.

### BACKGROUND

Photonic switches provide switching between inputs and outputs to provide a lightpath for signals. Photonic switches may be non-blocking allowing all inputs to be connected to all outputs. Non-blocking switches may be strictly non-blocking (SNB), which guarantees that any input can be connected to any available output regardless of existing connections. Non-blocking switches may alternatively be rearrangeably non-blocking (RNB), which guarantees that any input may be connected to any available output, however it may require rerouting existing connections through the switch in order to provide the connection. Non-blocking switches, whether strictly non-blocking or rearrangeably non-blocking, may have significant complexity to ensure that all of the inputs can be connected to all of the outputs in any order.

### SUMMARY

In accordance with the present disclosure there is provided a photonic switch comprising an N×N non-blocking switching core; 2N inputs reconfigurably connected to the N×N non-blocking switching core; and 2N outputs reconfigurably connected to the N×N non-blocking switching core, wherein in operation, the N×N non-blocking switching core provides a plurality of connections between a plurality of the 2N inputs and a plurality of the 2N outputs.

In an embodiment of the photonic switch, the N×N non-blocking switching core comprises a plurality of switching planes.

In a further embodiment of the photonic switch, each one of the plurality of switching planes is strictly non-blocking.

In a further embodiment of the photonic switch, each one of the plurality of switching planes is rearrangeably non-blocking.

In a further embodiment of the photonic switch, each one of the plurality of switching planes is blocking.

In a further embodiment of the photonic switch, the N×N non-blocking switching core comprises a plurality of individual switching cells with each individual switching cell supporting a single respective connection of the plurality of connections in operation.

In a further embodiment of the photonic switch, the N×N non-blocking switching core is a strictly non-blocking (SNB) photonic N×N non-blocking switching core.

In a further embodiment of the photonic switch, the N×N non-blocking switching core is based on a one of: a Dilated Banyan architecture; a Dilated Benes architecture; a Cantor architecture a route-and-select architecture; or a Clos architecture.

In a further embodiment of the photonic switch, the 2N inputs are connected to the N×N non-blocking switching core through N input switching modules.

In a further embodiment of the photonic switch, the N×N non-blocking switching core comprises j switching planes and each of the N input switching modules comprises a primary input, a secondary input and j outputs connecting the respective switching module to each of the j switching planes.

In a further embodiment of the photonic switch, the 2N outputs are connected to the N×N non-blocking switching core through N output switching modules.

In a further embodiment of the photonic switch, the N×N non-blocking switching core comprises j switching planes and each of the N output switching modules comprises a primary output, a secondary output and j inputs connecting the respective output switching module to each of the j switching planes.

In a further embodiment, the photonic switch further comprises a controller for routing the plurality of connections between the 2N inputs and 2N outputs through the N×N non-blocking switching core.

In a further embodiment of the photonic switch, the controller is configured to route the N connections between the 2N inputs and 2N outputs on a preferred basis.

In a further embodiment of the photonic switch, the controller is further configured to route one or more remaining connections between the 2N inputs and 2N outputs on a best-effort basis.

In a further embodiment of the photonic switch, the controller is configured to synchronously route 2N connections between the 2N inputs and 2N outputs through the N×N non-blocking switching core.

In accordance with the present disclosure there is provided a photonic network switch system comprising: a number, n, of photonic switches each comprising: an N×N non-blocking switching core; 2N inputs reconfigurably connected to the N×N non-blocking switching core; and 2N outputs reconfigurably connected to the N×N non-blocking switching core, where n is selected so that a probability of n-1 photonic switches being able to establish at least N additional connections is greater than a protection threshold.

In a further embodiment of the photonic network switch system, connections of a failed one of the photonic switches can be routed over the remaining n-1 photonic switches with a probability greater than the protection threshold.

In accordance with the present disclosure there is provided a method of expanding switching capabilities of a photonic switch comprising an N×N non-blocking switching core, N inputs reconfigurably connected to the N×N non-blocking switching core and N outputs reconfigurably connected to the N×N non-blocking switching core, the method comprising: connecting an additional N inputs to the N×N non-blocking switching core, to provide 2N inputs reconfigurably connected to the N×N non-blocking switching core; connecting an additional N outs to the N×N non-blocking switching core, to provide 2N outputs reconfigurably connected to the N×N non-blocking switching core.

In accordance with the present disclosure there is provided a method of establishing connections in a network switch comprising an N×N non-blocking switching core comprising log₂N switching planes reconfigurably connecting 2N inputs to 2N outputs, the method comprising: establishing N connections between N inputs and N outputs through a first portion of the switching planes; establishing N connections between remaining N inputs and N outputs through a second portion of the switching planes.

In a further embodiment, the method further comprises transmitting data over the established 2N connections for at least a time slot; and re-establishing the 2N connections at a beginning of a subsequent time slot.

### BRIEF DESCRIPTION OF THE DRAWINGS

Embodiments are described herein with reference to the appended drawings, in which:

FIG. 1 depicts a photonic switch in accordance with the present disclosure;

FIG. 2 depicts a method of routing connections in the photonic switch of FIG. 1;

FIG. 3 is a bar graph depicting probabilities of routing additional connections;

FIG. 4 depicts a photonic switch employing a non-blocking switching core with augmented inputs and outputs;

FIG. 5 depicts a photonic switch employing a 16×16 Cantor switching core with augmented inputs and outputs;

FIG. 6 depicts a photonic switch employing a route-and-select switching core with augmented inputs and outputs;

FIG. 7 depicts a further photonic switch with augmented inputs and outputs; and

FIG. 8 depicts a network switch system for utilizing available excess capacity of individual network switches.

### DETAILED DESCRIPTION

A non-blocking photonic switch may have significant unused capacity to ensure that all of the inputs can be connected to all of the outputs without blocking. Photonic switches generally comprise a non-blocking switching core connected between inputs and outputs. The switching core may be strictly non-blocking, which guarantees routing of connections regardless of established connections, or rearrangeably non-blocking, which can guarantee routing of connections with the possible re-routing of existing connections. As described herein, additional inputs and outputs may be added to a non-blocking photonic switch in order to make use of the excess capacity of the photonic switch. The additional inputs and outputs may be used to provide additional throughput. The additional throughput capacity provided by the switch may be used for various applications. For example, the additional switch may be used for routing traffic on a best-effort basis where no quality of service, or a reduced quality of service, is provided. Additionally or alternatively the additional capacity may be used to provide redundancy for groups of switches so that traffic of a failed switch may be carried over the additional inputs and outputs of the remaining switches. Further, if the switching core is strictly non-blocking, the capacity of the switch may be doubled if rearrangement of existing connections is allowed. Although the additional connections may be established through the non-blocking switching core, it may be possible to maintain a single connection per each individual switching cell which can reduce the optical cross-talk within the switching cells.

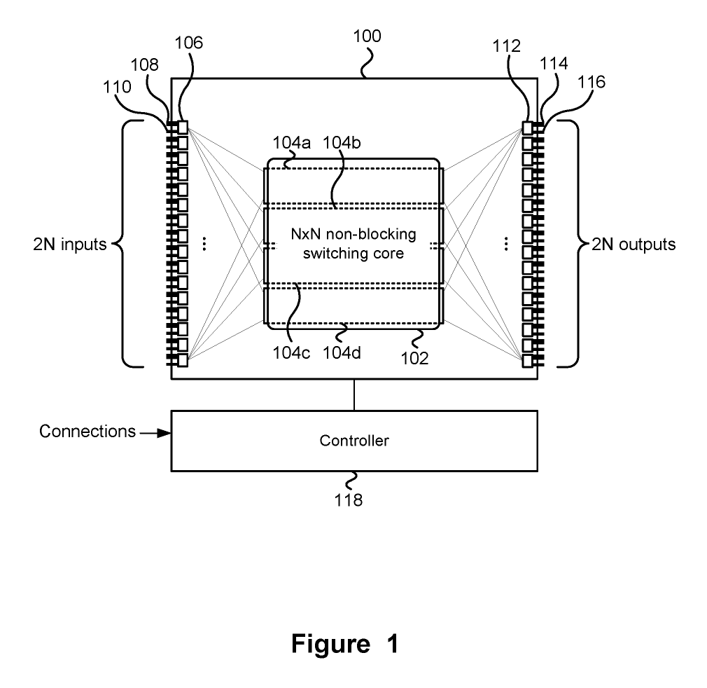

FIG. 1 depicts a photonic switch 100 in accordance with the present disclosure. The photonic switch 100 is depicted as a 16×16 non-blocking switch having augmented input/output (I/O) capacity; however similar I/O capacity augmentation may be applied to other sizes of switches. The photonic switch 100 is capable of guaranteeing the establishment of connections between 16 inputs and 16 outputs, as with a non-augmented 16×16 photonic switch. However, the photonic switch 100 having augmented I/O capacity is further capable of establishing 1 or more additional connections between the augmented inputs and outputs. Although the establishment of the additional connections is not guaranteed, it is likely that at least 4 additional connections may be established. The additional connections are established using excess capacity of the switching core that is required in order to provide the non-blocking switching between 16 inputs and outputs. Accordingly, the 16×16 photonic switch 100 with augmented I/O capacity may provide valuable performance improvements at a small additional expense of additional inputs and outputs since the switching capacity is already present.

The photonic switch 100 comprises a 16×16 non-blocking switching core 102 that is capable of guaranteeing the establishment of 16 connections between inputs and outputs. The non-blocking switching core 102 may establish the 16 connections while ensuring individual switching cells of the switching core only supports a single connection. It will be appreciated that while a single switching cell supports a single connection, the connection may be established over numerous switching cells. The non-blocking switching core 102 may be provided by various switching architectures, such as dilated Benes architectures, hybrid dilated Benes architectures, Cantor architectures, dilated Banyan architectures, route and select architectures, Clos architectures or other non-blocking switching architectures. The switching core 102 may comprise a plurality of similar switching planes. The switching core 102 is depicted as comprising 4 switching planes 104a, 104b, 104c, 104d (referred to collectively as switching planes 104). As an example, in the switching fabric 102, each of the switching planes 104 could be provided by a route and select module, a dilated Benes module, a hybrid

Benes module or other non-blocking modules. The individual switching planes may be strictly non-blocking planes, rearrangeably non-blocking planes or blocking planes.

The photonic switch 100 comprises a plurality of fan-out modules 106. The fan-out modules 106 allow an input signal from an input to be distributed to each of the switching planes 104 of the switching core. The fan-out modules 106 may be provided by a plurality of individual 2×2 switching cells connected together to selectively connect the primary input signal to one of 4 outputs. The individual switching cells of the fan-out modules 106 may support a single connection, or input signal, from the inputs to the non-blocking switching core. In order to provide a 16×16 switch, 16 fan-out modules 106 are required for distributing the 16 primary inputs to the switching planes 104 of the switching core 102. Similarly, the photonic switch 100 comprises a plurality of fan-in modules each for selectively coupling signals from each of the input planes to a primary output 114. The fan-in modules 112 may be provided by a plurality of individual 2×2 switching cells, which each support a single connection at a time, connected together to selectively connect one of 4 inputs to the primary output 114. It is noted that the terms input and output are not intended to relate to the direction of information flow that may be maintained over an established connection, but rather are intended to convey the two ends of an established connection. The information actually carried over an established connection may travel in either direction.

In order to make use of the excess capacity in the 16×16 non-blocking core 102 available after establishing the connections between the primary inputs 108 and primary outputs 112, the I/O capacity of the photonic switch 100 may be augmented by adding secondary, or additional, inputs 110 and outputs 116.

Each of the secondary inputs 110 and outputs 116 may be associated with a corresponding primary input 108 and output 114, respectively. Depending upon the specific structure of the fan-out modules 106, when the primary input 108 is coupled to a particular switching plane, for example switching plane 104a, the fan-out module 106 may still be able to selectively couple the secondary input 110 to a subset of the remaining switching planes such as switching planes 104c or 104d. The fan-out modules 106 may connect each of the primary and secondary inputs 108, 110 to the switching core 102 through separate individual switching cells of the fan-out modules 106.

Similarly, depending upon the specific structure of the fan-in modules 112, when the primary output 114 is coupled to a particular switching plane, for example switching plane 104a, the fan-in module 112 may still be able to selectively couple the secondary output 116 to a subset of the remaining switching planes such as switching planes 104c or 104d. The fan-in modules 112 may connect each of the primary and secondary outputs 114, 116 to the switching core 102 through separate individual switching cells of the fan-in modules 112.

The photonic switch 100 may include a control component 118 that receives connection requests and routes the requested connections between the inputs and outputs. The control component 118 may determine the routing and generate the appropriate control signals necessary for establishing the routed connections through the switching core 102. The control component 118 may be provided by an application specific integrated circuit (ASIC), a field programmable field array (FPGA), microcontroller or general purpose processor. The control component 118 may determine a routing path through the switching core 102 and provide the required electrical signals for controlling the individual photonic switching cells to establish the determined routing path.

By augmenting the I/O connections of a N×N non-blocking switch from N inputs and N outputs to 2N inputs and 2N outputs, the capacity of the switch may be increased without significantly increasing the complexity of the switch since much of the required components, such as the switching core and the switching cells at the inputs and outputs, are required to provide the non-blocking switch.

The addition of additional I/O capacity to the non-blocking switch may be used to provide increased throughput to potentially reduce delay during normal operation. The increased throughput may be used to provide protection against switch failures. For example, if switches are deployed in groups of M switches and one of the switches fails, the traffic previously carried by the failed switch may be carried over the augmented capacity of the remaining M-1 switches. Further, the augmented I/O capacity of the switch may be used to provide diverse service classes offerings. For example, since the switch is guaranteed to be able to establish the primary connections, these may be used to provide a first class of service that will always be routed. The secondary or augmented, connections may be used to provide a second class of service that is provide at a reduced cost but only on a best-effort basis. Further, if the switching core is strictly non-blocking, that is it can guarantee establishment of all primary connections regardless of when the connections are established, the augmented I/O capacity may be used to provide a switch of double the capacity operating as a rearrangeable non-blocking switch that can synchronously re-route all connections through the switching core. Due to the packet switching nature of data in data centers, limiting a switch to synchronous operation in order to double its capacity may be an acceptable trade-off.

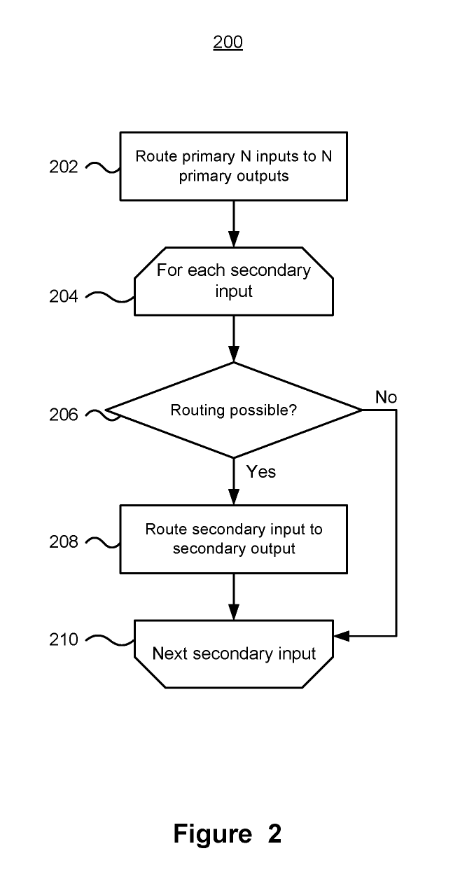

FIG. 2 depicts a method 200 of routing connections in the photonic switch of FIG. 1. The routing of connections provided by the method 200 may be implemented by a control component for the photonic switch. For example, the method 200 may be implemented by the control component 118 described above. The method 200 begins with routing the primary connections (202) between the N primary inputs and N primary outputs. The routing of the primary connections may be accomplished using known routing techniques. As described above, the switching core is a non-blocking core and as such the primary connections are guaranteed to be established. Once the primary connections have been established through the switching core, the method attempts to establish secondary connections. For each of the potential connections of the secondary inputs (204), the method determines if routing is possible (206) for establishing the connection and if it is not possible (No at 206) the next secondary input is considered (208). If the routing of the connection from the secondary input is possible (Yes at 206) the secondary connection is established between the secondary input and output (210). The secondary connections may be established using various routing techniques, such as described in U.S. application Ser. No. 14/828,019, filed Aug. 17, 2015 entitled “METHOD AND APPARATUS FOR SIGNAL ROUTING IN A MULTI-PLANE PHOTONIC SWITCH”, which is incorporated herein by reference in its entirety.

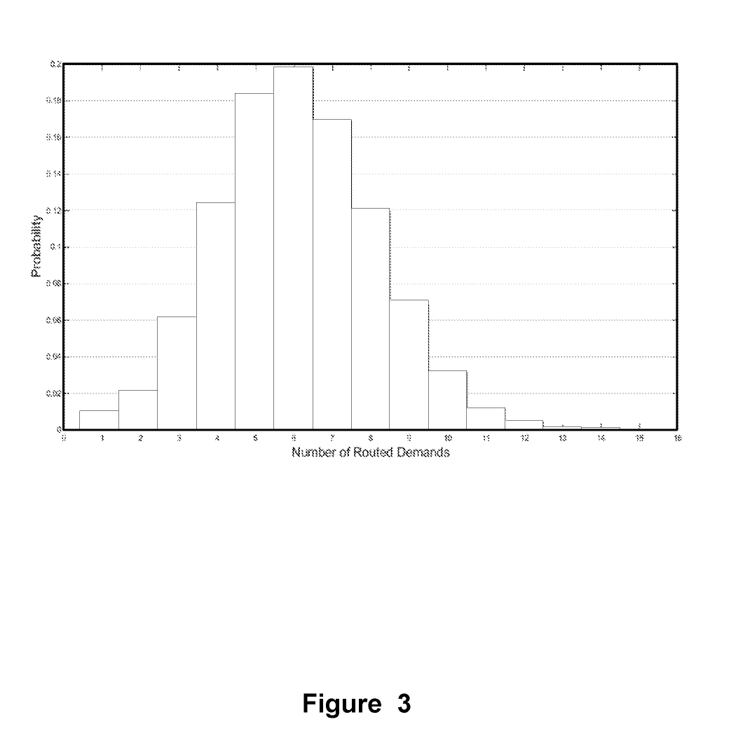

FIG. 3 is a bar graph depicting probabilities of routing additional connections. As described above, once the primary connections are established, the secondary connections are attempted to be established. Depending upon the routes through the switching core used for establishing the primary connections, a varying number of secondary connections may be established. The number of secondary routes that were established was repeatedly simulated and the results are shown in the graph 300. The graph depicts the probability of establishing a particular number of additional connections after the primary connections were established. From the graph 300, it can be seen that at least one secondary connection is always possible to be established and 14 secondary connections was the greatest number of secondary connections that was established. 4 or more secondary connections were established approximately 90% of the time. 5 or more secondary connections were established approximately 78% of the time, and 6 or more secondary connections were established approximately 60% of the time.

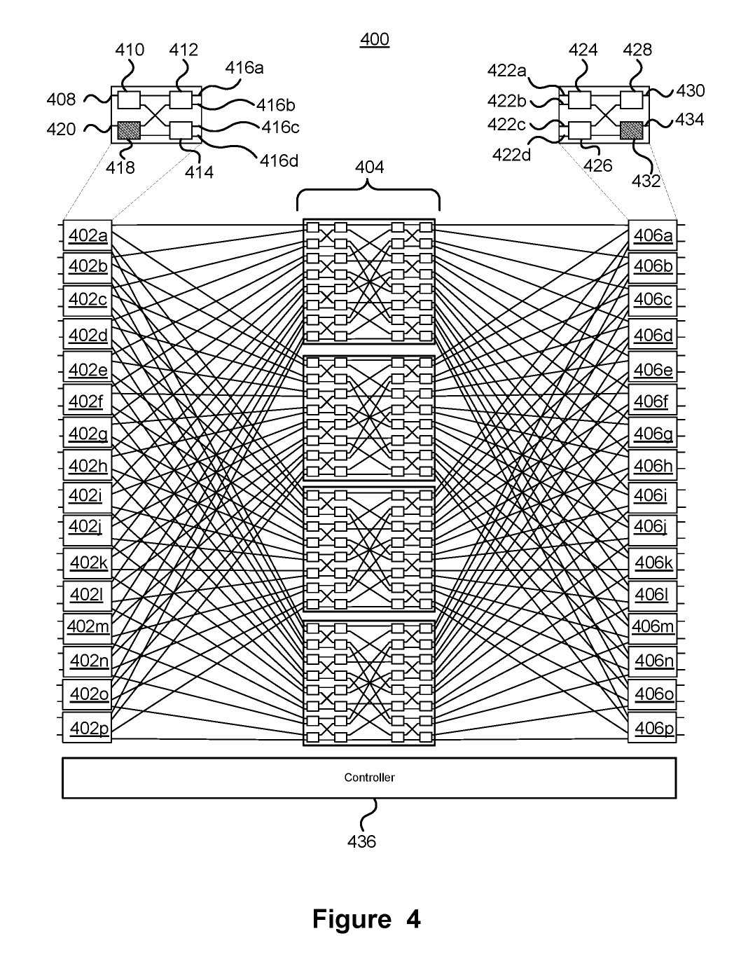

FIG. 4 depicts a photonic switch 400 employing a non-blocking switching core with augmented I/O. The photonic switch 400 is depicted as having a 16×16 non-blocking switching core connected to 32 inputs and 32 outputs. Each of the inputs is connected to respective one of the fan-out switching modules 402a-402p (referred to as fan-out switching modules 402) that fans out the inputs to selectively couple the inputs to switching planes of a switching core 404. The switching core 404 is depicted as comprising 4 switching planes of a non-blocking architecture. The switching core 404 can be controlled by a control component 436 to selectively connect inputs to outputs. Each of the 32 outputs are connected to a respective one of the fan-in switching modules 406a-406p (referred to collectively as fan-in switching modules 406).

The fan-out switching modules 402 used to distribute the input signal to the switching planes of the switching core 404 comprises a primary input 408 and a secondary input 420. The switching modules 402 may comprise a plurality of individual photonic switching cells, which selectively establish desired connections under the control of the control component 436. As depicted, in order to connect the primary input 408 to each of the switching planes of the switching core 404, the input 408 is coupled through a plurality, namely 3, individual photonic switching cells 410, 412, 414. Each of the individual switching cells comprises two inputs and two outputs and is able to selectively switch the connections between the inputs and outputs. Two of the switching cells, 412 and 414 in FIG. 4, provide the required output connections 416a-416d to the switching planes. One of the switching cells, 410 in FIG. 4 selectively couples the primary input 408 to one of the other switching cells 412, 414. The switching modules 402 include an additional switching cell, or cells if required, for selectively coupling the secondary input 420 to the switching cells 412, 410, and so the switching planes. It is noted that each of the switching cells 410 and 418 are connected to a single input. A single switching cell may be able to switch the two inputs; however, switching two signals in a single switching cell may result in undesirable cross-talk between the signals. Accordingly, the switches described herein preferably switch only a single signal over each cell to provide improved cross-talk performance.

The fan-in switching modules 406 are similar in structure to the fan-out switching modules 402. The fan-in switching modules 406 comprise a plurality of inputs 422a-422d connected to each of the switching planes of the switching core 404. The inputs 422a-422d are connected to individual switching cells 424, 426 which are connected to switching cell 428 providing the primary output 430. The individual switching cells 424, 426 are also connected to an additional switching cell 432 for providing the secondary output 434. The route through the fan-in switching modules 406 may be established by the control component 436.

The photonic switch architecture described above provides useable excess capacity at the expense of adding additional I/O components. As depicted above, the additional expense of augmenting the I/O capacity may be relatively small, for example a single additional photonic switching cell for each additional input and output.

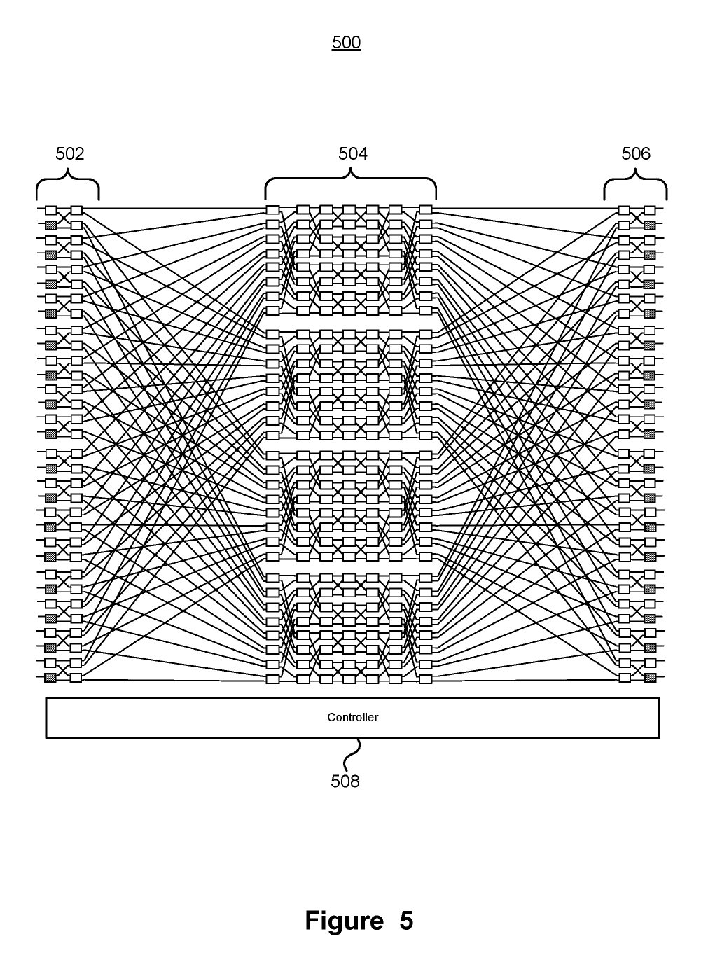

FIG. 5 depicts a photonic switch 500 employing a 16×16 Cantor switching core with augmented inputs and outputs. The photonic switch 500 is similar to those described above. The photonic switch 500 is a 16×16 Cantor switch having augmented I/O capacity so that instead of having only 16 inputs and outputs, it has 32 inputs and outputs. An N×N Cantor switching core comprises m=log₂N of N×N Benes switching planes. Each block in FIG. 5 represents an individual photonic switch capable of selectively establishing connections between two inputs and two outputs. The photonic switch 500 comprises an input switching section 502 comprising a plurality of switching modules for selectively coupling primary inputs to the switching planes of the switching core 504. The switching modules 502 include an additional switching cell, depicted as a shaded cell in FIG. 5, for selectively coupling a secondary input to the switching planes to make use of excess capacity of the switching core. Similarly, the output switching section 506 comprises a plurality of switching modules for selectively coupling each of the switching planes of the switching core 504 to the primary outputs. The switching modules comprise additional switching cells, depicted as shaded cells in FIG. 5, for selectively coupling the switching planes to secondary outputs. The routing of the connections through the switch 500 may be determined by a control component 508. The determined routes may be established by the control component 508 by providing appropriate electrical signals to control the switching cells.

The 16×16 Cantor switching core provides a strictly non-blocking core that can asynchronously route 16 connections over 4 switching planes. With the augmented I/O, the switch may be operated synchronously in order to route 32 connections. The synchronous operation in the datacenter may allow rearrangement of all connection between time-slots (gap time). In a datacenter environment, connection requests for the next time-slot arrive to a switch controller during a current time-slot. The controller can determine the route and rearrangement scheme to route 16 connection requests through a first half of the switching planes, and then route an additional 16 connection requests through the second half of the switching planes. The determined connection routing may then be applied during the gap and the data communicated over the established connections in the next slot. The process continues over time as data is transmitted in packets. The communications may be routed over paths such that only one signal is carried by each switching cell reduces crosstalk between signals. When the switching core is provided by a Cantor 16×16, it is possible to rearrange 16 possible connections to be routed through 2 planes of Cantor 16×16. With the augmented I/O, capabilities, it is possible to use the remaining 2 switching planes to route 16 additional connections using the remaining 2 switching planes.

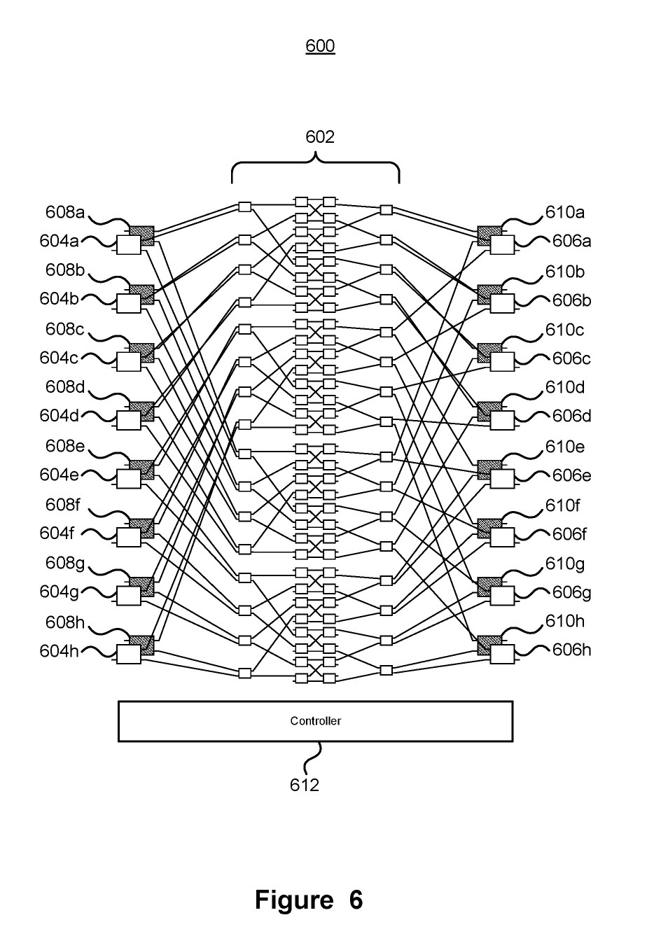

FIG. 6 depicts a photonic switch 600 employing a route-and-select switching core. The above has described photonic switches using a Cantor or Benes or other non-blocking types switching core. The augmentation of I/O capacity may be applied to switches having other switching cores such as route and select. The photonic switch 600 comprises an 8×8 route and select switching core 602 that can guarantee establishment of 8 primary connections between primary inputs 604a-604h and outputs 606a-606h. The I/O capacity of the switch 600 has been augmented with secondary inputs 608a-608h and outputs 610a-610h. The augmented I/O capacity allows excess capacity of the route and select switching core to be used to route additional connections, if possible. The routing of the connections through the switch may be determined by a control component 612. The determined routes may be established by the control component 612 by providing appropriate electrical signals to control the switching cells.

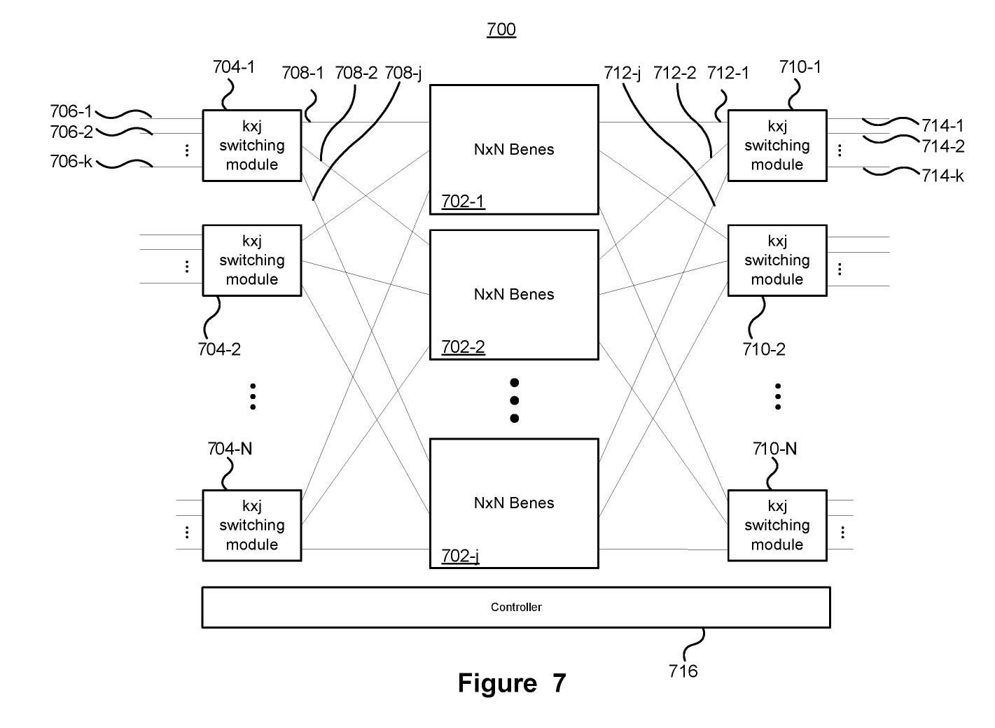

FIG. 7 depicts a further photonic switch 700 having augmented I/O capacity. As depicted, the photonic switch 700 comprises j N×N switching planes 702-1, 702-2, 702-j. The switching planes 702-1, 702-2, 702-j are depicted as being N×N Benes switching modules, however, other switching plane architectures may be used. Each of the j switching planes are connected to N input switching modules 704-1, 704-2, 704-N and N output switching modules 710-1, 710-2, 710-N. Each of the switching modules 704-1, 704-2, 704-N can selectively establish connections between inputs and outputs. Each of the N input switching modules is substantially similar, and comprises k inputs 706-1, 706-2, 706-k that can be selectively coupled to one of the j outputs 708-1, 708-2, 708-j of the switching modules. One of the inputs, for example 706-1, may be considered a primary input whose connection is guaranteed to be established, while the remaining k-1 inputs may be considered secondary, or augmented, inputs whose connections are established on a best-effort basis after establishing all of the primary connections. Similarly, the N output switching modules 710-1, 710-2, 710-N selectively couple the switching plane outputs 712-1, 712-2, 712-j to the k switching module outputs 714-1, 714-2, 714-k. As with the inputs, one of the outputs, for example output 714-1, may be considered a primary output for establishing the primary connections. Once all primary connections have been established, the remaining k-1 outputs may be used in attempting to establish secondary connections. The routing of the connections through the switch may be determined by a control component 716. The determined routes may be established by the control component 716 by providing appropriate electrical signals to control the switching cells.

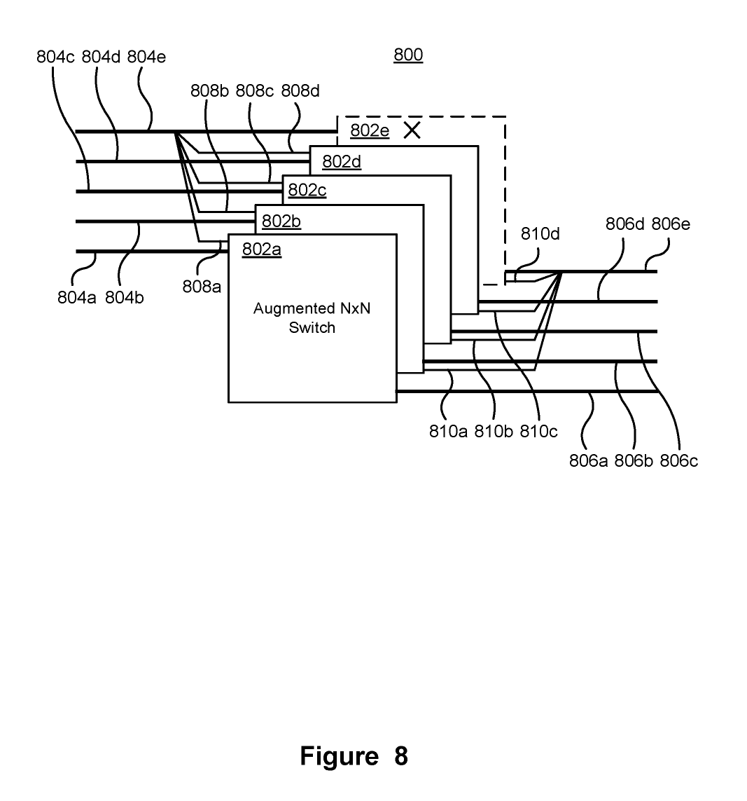

FIG. 8 depicts a network switch system 800 for utilizing available excess capacity of individual network switches. The system 800 comprises a plurality of augmented N×N switches 802a, 802b, 802c, 802d, 802e (referred to collectively as augmented switches 802) each having augmented I/O to allow potentially 2N connections. A number of augmented switches 802 are grouped together in a protection group. As depicted in the Figure, 5 augmented switches are grouped together to provide protection against failure of one of the switches of the group. Each of the individual augmented switches 802 are able to guarantee establishing N primary connections between primary inputs, depicted as connections 804a, 804b, 804c, 804d, 804e, and primary outputs, depicted as connections 806a, 806b, 806c, 806d, 806e. Each of the augmented switches 802 may attempt to establish additional connections on a best effort basis.

The system 800 combines a number of the augmented switches 802 grouped together in order to provide protection against failure of one of the individual augmented switches 802. For example, if one of the augmented switches 802 fails, depicted as switch 802e, the primary connections of the augmented switch 802e can be routed over the additional capacity of the remaining augmented switches, depicted by input connections 808a, 808b, 808c, 808d, 808e and output connections 810a, 810b, 810c, 810d, 810e. The number of switches to group together to provide failure protection depends upon a protection threshold, and the probability that the remaining switches will be able to establish the required connections over the excess capacity. For example, as depicted in FIG. 3, an augmented switch may be able to route an additional 4 or more connections approximately 90% of the time. Accordingly, if a total of 5 augmented switches are used in a protection group and one fails, the remaining 4 augmented switches could route the 16 primary connections of the failed switch approximately 90% of the time. If greater protection was desired, additional augmented switches could be added to the system 800. Accordingly, the number of augmented switches is selected so that a probability the combined remaining photonic switch being able to establish connections for the primary connections of the failed switch is above a protection threshold.

Although other values of N, j and k are possible, N is generally selected to be N=2ⁿ|n ε [symbol] >=2. Although other values may be used, j may be set according to j=log₂ N. The number of I/O available may be set according k ε [symbol] >=2, with k≦j.

Various photonic switches have been described above that provide augmented I/O capacity to make use of excess capacity available in the switching core. The control of the switching components for establishing both primary and secondary connections may be provided by various routing, or path finding, algorithms performed by a control component, which is not depicted. For example, each of the individual switching elements may be controlled electrically, with the control signals provided by a microprocessor or microcontroller that executes the control algorithm. Further, although the inputs and outputs have been described as being either ‘primary’ or ‘secondary’ the distinction is mainly a logical one with primary inputs/outputs being those used to establish the initial connections that are guaranteed to be able to be established. Further, the distinction between input and output directions is not related to the direction of data carried over established connections, but rather is used for clarity of the description. That is data can flow bi-directionally between inputs and outputs.

In order to ensure that the connections can be established, the switching core has excess capacity than required for establishing the connections. The switching capabilities of the photonic switch may be augmented by connecting an additional N inputs to the N×N non-blocking switching core, to provide 2N inputs reconfigurably connected to the N×N non-blocking switching core and connecting an additional N outs to the N×N non-blocking switching core, to provide 2N outputs reconfigurably connected to the N×N non-blocking switching core. By augmenting the switch with additional I/O capacity the excess capacity can be used to establish one or more additional connections.

The present disclosure provided, for the purposes of explanation, numerous specific embodiments, implementations, examples and details in order to provide a thorough understanding of the invention. It is apparent, however, that the embodiments may be practiced without all of the specific details or with an equivalent arrangement. In other instances, some well-known structures and devices are shown in block diagram form, or omitted, in order to avoid unnecessarily obscuring the embodiments of the invention.

The description should in no way be limited to the illustrative implementations, drawings, and techniques illustrated, including the exemplary designs and implementations illustrated and described herein, but may be modified within the scope of the appended claims along with their full scope of equivalents.

While several embodiments have been provided in the present disclosure, it should be understood that the disclosed systems and components might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What is claimed is:

1. A photonic switch comprising:
an N×N non-blocking switching core;
2N inputs reconfigurably connected to the N×N non-blocking switching core; and
2N outputs reconfigurably connected to the N×N non-blocking switching core,
wherein in operation, the N×N non-blocking switching core provides a plurality of connections between a plurality of the 2N inputs and a plurality of the 2N outputs.

2. The photonic switch of claim 1, wherein the N×N non-blocking switching core comprises a plurality of switching planes.

3. The photonic switch of claim 2, wherein each one of the plurality of switching planes is strictly non-blocking.

4. The photonic switch of claim 2, wherein each one of the plurality of switching planes is rearrangeably non-blocking.

5. The photonic switch of claim 2, wherein each one of the plurality of switching planes is blocking.

6. The photonic switch of claim 2, wherein the N×N non-blocking switching core comprises a plurality of individual switching cells with each individual switching cell supporting a single respective connection of the plurality of connections in operation.

7. The photonic switch of claim 1, wherein the N×N non-blocking switching core is a strictly non-blocking (SNB) photonic N×N switching core.

8. The photonic switch of claim 1, wherein the N×N non-blocking switching core is based on a one of:
a Dilated Banyan architecture;
a Dilated Benes architecture;
a Cantor architecture;
a route-and-select architecture; or
a Clos architecture.

9. The photonic switch of claim 1, wherein the 2N inputs are connected to the N×N non-blocking switching core through N input switching modules.

10. The photonic switch of claim 9, wherein the N×N non-blocking switching core comprises j switching planes and each of the N input switching modules comprises a primary input, a secondary input and j outputs connecting the respective switching module to each of the j switching planes.

11. The photonic switch of claim 1, wherein the 2N outputs are connected to the N×N non-blocking switching core through N output switching modules.

12. The photonic switch of claim 11, wherein the N×N non-blocking switching core comprises j switching planes and each of the N output switching modules comprises a primary output, a secondary output and j inputs connecting the respective output switching module to each of the j switching planes.

13. The photonic switch of claim 1, further comprising a controller for routing the plurality of connections between the 2N inputs and 2N outputs through the N×N non-blocking switching core.

14. The photonic switch of claim 13, wherein the controller is configured to route the N connections between the 2N inputs and 2N outputs on a preferred basis.

15. The photonic switch of claim 14, wherein the controller is further configured to route one or more remaining connections between the 2N inputs and 2N outputs on a best-effort basis.

16. The photonic switch of claim 13, wherein the controller is configured to synchronously route 2N connections between the 2N inputs and 2N outputs through the N×N non-blocking switching core.

17. A photonic network switch system comprising:
a number, n, of photonic switches each comprising:
an N×N non-blocking switching core;
2N inputs reconfigurably connected to the N×N non-blocking switching core; and
2N outputs reconfigurably connected to the N×N non-blocking switching core,
where n is selected so that a probability of n-1 photonic switches being able to establish at least N additional connections is greater than a protection threshold.

18. The photonic network switch system of claim 17, wherein connections of a failed one of the photonic switches can be routed over the remaining n-1 photonic switches with a probability greater than the protection threshold.

19. A method of establishing connections in a network switch comprising an N×N non-blocking switching core comprising log₂N switching planes reconfigurably connecting 2N inputs to 2N outputs, the method comprising:
establishing N connections between N inputs and N outputs through a first portion of the switching planes;
establishing N connections between remaining N inputs and N outputs through a second portion of the switching planes.

20. The method of claim 19, further comprising:
transmitting data over the established 2N connections for at least a time slot;
re-establishing the 2N connections at a beginning of a subsequent time slot.
